(19) United States
(12) Patent Application Publication
(10) Pub. No.: US 2026/0098786 A1
(43) Pub. Date: Apr. 9, 2026

(54) MISFIRE DIAGNOSIS DEVICE

(71) Applicant: SUZUKI MOTOR CORPORATION, Hamamatsu-shi (JP)

(72) Inventor: Kohei YAMAMOTO, Hamamatsu-shi (JP)

(73) Assignee: SUZUKI MOTOR CORPORATION, Hamamatsu-shi (JP)

(21) Appl. No.: 19/304,344

(22) Filed: Aug. 19, 2025

(30) Foreign Application Priority Data
Oct. 7, 2024 (JP) 2024-175942

(51) Int. Cl. G01M 15/05

(52) U.S. Cl. CPC G01M 15/05

(57) ABSTRACT

A misfire diagnosis device that diagnoses presence or absence of a misfire in an engine having a plurality of cylinders, includes: a setting unit configured to set a calculation interval to a period during which at least all cylinders make one cycle of ignition; a recording unit configured to record a crank angular acceleration from one cylinder ignition to next cylinder ignition for each cylinder; a calculation unit configured to calculate a difference between a maximum value and a minimum value of the crank angular acceleration in the calculation interval for each cylinder; and a diagnosis unit configured to diagnose, for each cylinder, a cylinder for which the difference in the crank angular acceleration is equal to or greater than a threshold value as a misfiring cylinder.

### CROSS-REFERENCE TO RELATED APPLICATION(S)

This application is based on and claims priority under 35 USC 119 from Japanese Patent Application No. 2024-175942 filed on Oct. 7, 2024, the entire content of which is incorporated herein by reference.

### TECHNICAL FIELD

The present invention relates to an engine misfire diagnosis device.

### BACKGROUND ART

In recent years, there has been known an abnormality diagnosis device that diagnoses abnormalities in each cylinder of an engine (see, for example, Patent Literature 1). In the abnormality diagnosis device described in Patent Literature 1, a difference between an instantaneous minimum rotational speed and an instantaneous maximum rotational speed during a power stroke for each cylinder is calculated as a rotational fluctuation time difference. The rotational fluctuation time difference is calculated for each cylinder, and a rotational fluctuation deviation is calculated for each cylinder from the rotational fluctuation time difference for each cylinder and an average value of the rotational fluctuation time differences for all cylinders. The rotational fluctuation deviation is then compared with a preset threshold value to diagnose a misfire state due to insufficient combustion in each cylinder, as well as abnormalities such as insufficient fuel injection by an injector or excessive fuel injection.

### CITATION LIST

### Patent Literature

Patent Document 1: JP3861550B

However, in the abnormality diagnosis device described in Patent Literature 1, index values such as rotational speed are calculated for each ignition, and since ignition intervals are short in a multi-cylinder engine, fluctuations in the index values cannot be fully captured. For this reason, there is a risk that a misfiring cylinder cannot be identified with high accuracy.

### SUMMARY

The present invention is made in consideration of the above-described problems, and an object of the present invention is to provide a misfire diagnosis device and a program that can accurately diagnose a misfiring cylinder in a multi-cylinder engine.

A misfire diagnosis device of an aspect of the present invention is a misfire diagnosis device that diagnoses presence or absence of a misfire in an engine having a plurality of cylinders, including: a setting unit configured to set a calculation interval to a period during which at least all cylinders make one cycle of ignition; a recording unit configured to record a crank angular acceleration from one cylinder ignition to next cylinder ignition for each cylinder; a calculation unit configured to calculate a difference between a maximum value and a minimum value of the crank angular acceleration in the calculation interval for each cylinder; and a diagnosis unit configured to diagnose, for each cylinder, a cylinder for which the difference in the crank angular acceleration is equal to or greater than a threshold value as a misfiring cylinder.

In the misfire diagnosis device according to the aspect of the present invention, the crank angular acceleration is an index indicating whether the rotational speed of the crankshaft is increasing or decreasing. Since the crank angular acceleration shows a decreasing tendency due to a decrease in combustion energy caused by a misfire, the difference between the maximum value and the minimum value of the crank angular acceleration becomes large when a cylinder misfires. Misfiring cylinders are diagnosed by monitoring the difference in crank angular acceleration for each cylinder. In addition, since the crank angular acceleration from one cylinder ignition to the next cylinder ignition is used, a misfiring cylinder can be diagnosed with high accuracy without being affected by the next cylinder ignition.

### BRIEF DESCRIPTION OF DRAWINGS

FIG. 1 is a functional block diagram of an engine system according to a first example.

FIG. 2 is a functional block diagram of a misfire diagnosis device according to the first example.

FIG. 3 is a time chart of misfiring cylinder diagnosis according to the first example.

FIG. 4 is a flowchart of a recording process for the misfiring cylinder diagnosis according to the first example.

FIG. 5 is a flowchart of a calculation process for the misfiring cylinder diagnosis according to the first example.

FIG. 6 is a functional block diagram of a misfire diagnosis device according to a second example.

FIG. 7 is a time chart of misfire diagnosis according to the second example.

FIG. 8 is a flowchart of a recording process for the misfire diagnosis according to the second example.

FIG. 9 is a flowchart of a calculation process for the misfire diagnosis according to the second example.

FIG. 10 is a flowchart of a recording process for misfiring cylinder diagnosis according to the second example.

FIG. 11 is a flowchart of a calculation process for the misfiring cylinder diagnosis according to the second example.

### DESCRIPTION OF EMBODIMENTS

A misfire diagnosis device according to an aspect of the present invention diagnoses presence or absence of a misfire in an engine having a plurality of cylinders. In the misfire diagnosis device, a setting unit sets a calculation interval to a period during which at least all cylinders make one cycle of ignition, and a recording unit records a crank angular acceleration from one cylinder ignition to next cylinder ignition for each cylinder. A calculation unit calculates a difference between a maximum value and a minimum value of the crank angular acceleration in the calculation interval for each cylinder, and a diagnosis unit diagnoses a cylinder for which the difference in the crank angular acceleration is equal to or greater than a threshold value as a misfiring cylinder. The crank angular acceleration is an index indicating whether the rotational speed of a crankshaft is increasing or decreasing. Since the crank angular acceleration shows a decreasing tendency due to a decrease in combustion energy caused by a misfire, the difference between the maximum value and the minimum value of the crank angular acceleration becomes large when a cylinder misfires. Misfiring cylinders are diagnosed by monitoring the difference in crank angular acceleration for each cylinder. In addition, since the crank angular acceleration from one cylinder ignition to the next cylinder ignition is used, a misfiring cylinder can be diagnosed with high accuracy without being affected by the next cylinder ignition.

### EXAMPLES

### First Example

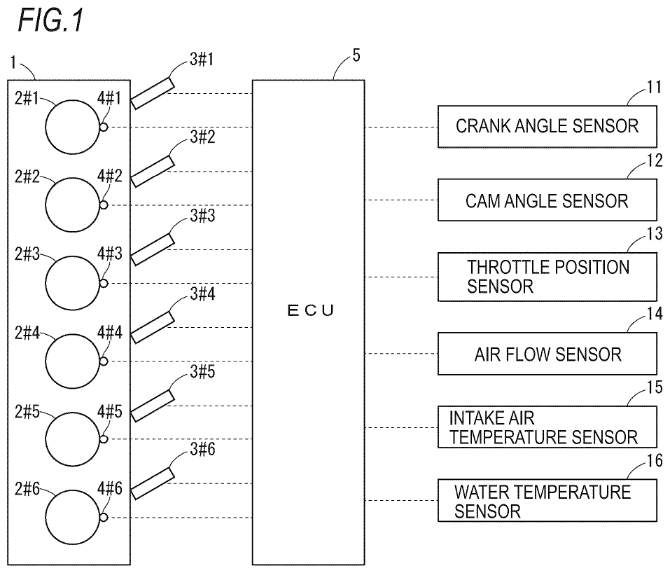

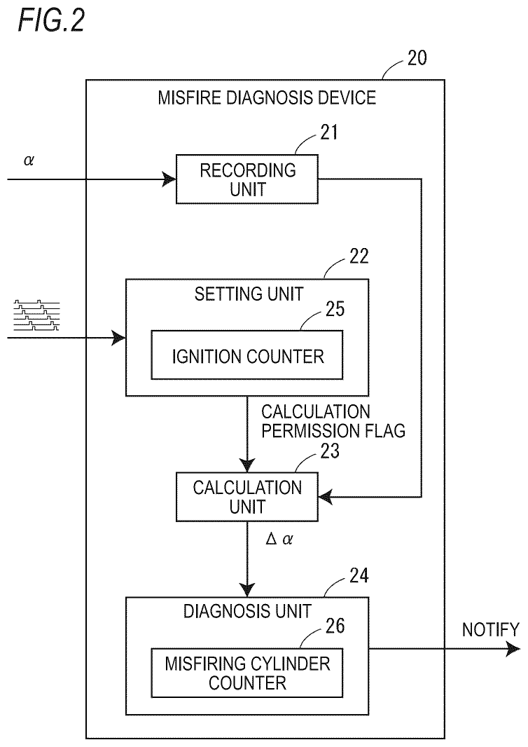

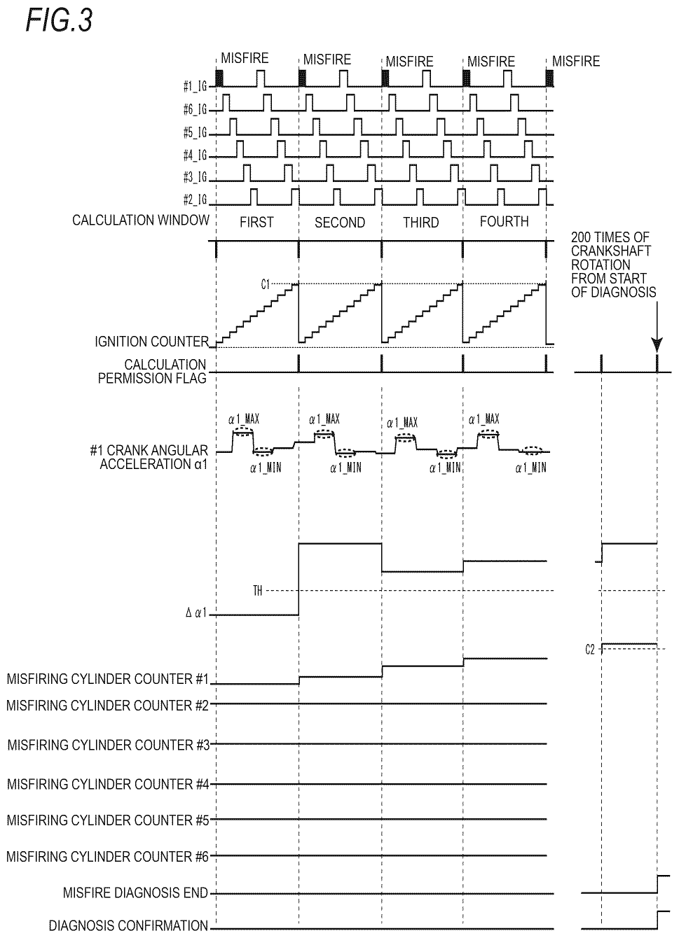

A misfire diagnosis device according to a first example will be described with reference to the accompanying drawings. FIG. 1 is a functional block diagram of an engine system according to a first example. FIG. 2 is a functional block diagram of a misfire diagnosis device of the first example. FIG. 3 is a time chart of misfiring cylinder diagnosis according to the first example.

As illustrated in FIG. 1, an engine 1 is a four-stroke engine that repeats an intake stroke, a compression stroke, an expansion stroke, and an exhaust stroke. The engine 1 is formed with cylinders 2 #1 to 2 #6, and the respective cylinders 2 #1 to 2 #6 are provided with intake valves (not illustrated), exhaust valves (not illustrated), fuel injection valves 3 #1 to 3 #6, and spark plugs 4 #1 to 4 #6. An Electronic Control Unit (ECU) 5 controls fuel injection from the fuel injection valves 3 #1 to 3 #6 and ignition from the spark plugs 4 #1 to 4 #6, so that the cylinders 2 #1 to 2 #6 are ignited in sequence at crank angle intervals of 120°, and ignition of all cylinders is repeated periodically.

The ECU 5 is connected to a group of sensors such as a crank angle sensor 11, a cam angle sensor 12, a throttle position sensor 13, an air flow sensor 14, an intake air temperature sensor 15, a water temperature sensor 16, and the like. The crank angle sensor 11 outputs a signal corresponding to a rotation angle of a crankshaft (not illustrated), and the cam angle sensor 12 outputs a signal corresponding to a rotation angle of a camshaft (not illustrated). The throttle position sensor 13 outputs a signal corresponding to a throttle opening degree, and the air flow sensor 14 outputs a signal corresponding to the amount of intake air. The intake air temperature sensor 15 outputs a signal corresponding to an intake air temperature, and the water temperature sensor 16 outputs a signal corresponding to a cooling water temperature of the engine 1.

Based on output results of the crank angle sensor 11, the cam angle sensor 12, the throttle position sensor 13, the air flow sensor 14, the intake air temperature sensor 15, and the water temperature sensor 16, the ECU 5 determines ignition timing and performs various controls. In response to a signal from the crank angle sensor 11, the ECU 5 calculates a crank angular velocity for each cylinder by dividing an angle difference between a currently detected crank angle and a previously detected crank angle by a time interval between the detection times. Furthermore, an angular velocity difference between a currently calculated crank angular velocity and a previously calculated crank angular velocity is divided by the time interval between the detection times to obtain a crank angular acceleration for each cylinder. A method of calculating the crank angular acceleration is not limited.

As illustrated in FIGS. 2 and 3, a misfire diagnosis device 20 is connected to the engine 1, which diagnoses whether the engine 1 having a plurality of cylinders has a misfire. In the misfire diagnosis device 20 of the first example, the ignition of all cylinders 2 #1 to 2 #6 is comprehensively monitored. The misfire diagnosis device 20 includes a setting unit 22 that sets a calculation interval to a period during which at least all cylinders 2 #1 to 2 #6 make one cycle of ignition, a recording unit 21 that records a crank angular acceleration from the cylinder ignition to the next cylinder ignition for each cylinder, a calculation unit 23 that calculates a difference between a maximum value and a minimum value of the crank angular acceleration in the calculation interval for each cylinder, and a diagnosis unit 24 that diagnoses, for each cylinder, a cylinder for which the difference in the crank angular acceleration is equal to or greater than a threshold value as being in a misfire state.

The setting unit 22 receives a pulse signal from the ECU 5 in accordance with the ignition timing of each of the cylinders 2 #1 to 2 #6. The setting unit 22 is provided with an ignition counter 25, which increments count every time an ignition occurs in each of the cylinders 2 #1 to 2 #6 based on the pulse signal. Counting begins after an open flag of a calculation window is set, and when the ignition counter 25 exceeds a predetermined value C1, it is returned to the first count. When the ignition counter 25 reaches a count of one, an open flag for a next calculation window is set. A counting period from when the open flag of the calculation window is set to the predetermined value C1 of the ignition counter 25 is set as the calculation interval.

In the first example, the setting unit 22 sets a period during which all the cylinders 2 #1 to 2 #6 undergo a plurality of ignitions as the calculation interval. Specifically, 12 counts are set as the predetermined value C1 in the ignition counter 25, and the period until the ignition of all cylinders 2 #1 to 2 #6 goes around two times and the count reaches 12 is set as the calculation interval. It is possible to diagnose a misfire state including the case where a particular cylinder misfires only once in a plurality of times (two times). When the ignition counter 25 reaches a count of 12, the setting unit 22 sets a calculation permission flag, which indicates that the first calculation interval has elapsed.

The recording unit 21 records a crank angular acceleration α calculated by the ECU 5 for each cylinder. When a misfire occurs in a cylinder, a combustion energy decreases due to the misfire, so the crank angular acceleration α of the misfiring cylinder tends to decrease. The misfire diagnosis device 20 diagnoses misfiring cylinder by utilizing characteristics of the crank angular acceleration α. The crank angular acceleration α of a cylinder is recorded in an interval from the ignition of the cylinder to the ignition of the next cylinder, and the crank angular acceleration α of a cylinder is not affected by the ignition of the next cylinder. For example, a crank angular acceleration al of the cylinder 2 #1 is recorded in an interval from the ignition of the cylinder 2 #1 to the ignition of the next cylinder 2 #6.

When the calculation permission flag is set in the setting unit 22, the calculation unit 23 calculates a difference between the maximum value α_MAX and the minimum value α_MIN of the crank angular acceleration α in the calculation interval for each cylinder. That is, the crank angular acceleration α in the calculation interval until the calculation permission flag is set is monitored for each cylinder, the calculation unit 23 obtains the maximum value α_MAX and the minimum value α_MIN from the crank angular acceleration α, and the calculation unit 23 further calculates a difference Δα between the maximum value α_MAX and the minimum value α_MIN of the crank angular acceleration. For example, a maximum value al MAX and a minimum value α1_MIN of the crank angular acceleration α1 of the cylinder 2 #1 in the calculation interval are obtained, and a difference Δα1 between the maximum value α1 MAX and minimum value α1_MIN of the crank angular acceleration is calculated.

In the diagnosis unit 24, the difference Δα in the crank angular acceleration of each cylinder is compared with a threshold value TH for each calculation interval. A cylinder for which the difference Δα in crank angular acceleration is equal to or greater than the threshold value TH is diagnosed as a misfiring cylinder, and a cylinder for which the difference Δα in crank angular acceleration is less than the threshold value TH is diagnosed as a non-misfiring cylinder. The diagnosis unit 24 is also provided with a misfiring cylinder counter 26 for each cylinder, and the misfiring cylinder counter 26 increments count each time the diagnosis unit 24 diagnoses a misfiring cylinder. Then, when a diagnosis period has elapsed, the diagnosis unit 24 performs a final diagnosis, and when the count value (the number of times the cylinder has been diagnosed as a misfiring cylinder) of the misfiring cylinder counter 26 is equal to or greater than a predetermined value (predetermined number of times) C2, the diagnosis unit 24 confirms that the cylinder is a misfiring cylinder and issues a notification.

In this manner, when the diagnosis unit 24 repeatedly diagnoses a misfiring cylinder, the misfiring cylinder is confirmed, thereby improving the diagnostic accuracy. The threshold value TH and the predetermined values C1 and C2 are set to values experimentally, empirically, and theoretically obtained from past data or the like. A rotational speed of the crankshaft is set as the diagnosis period. When the rotational speed of the crankshaft reaches a predetermined rotational speed from the start of the diagnosis, the misfiring cylinder counter 26 is reset. FIG. 3 illustrates only the crank angular acceleration α1 and the difference Δα1 in the crank angular acceleration of the cylinder 2 #1, but in reality, recording and calculation are also performed for the cylinders 2 #2 to 2 #6.

Each control block of the misfire diagnosis device 20 may be realized by software using a processor, or may be realized by a logic circuit (hardware) formed in an integrated circuit or the like. When the processor is used, the processor reads and executes a program stored in a memory to perform various processes. As the processor, for example, a Central Processing Unit (CPU) is used. The memory is composed of one or more storage media such as a Read Only Memory (ROM) and a Random Access Memory (RAM) depending on the application.

An example of misfiring cylinder diagnosis will be described below. As illustrated in FIG. 3, ignition is repeated in the order of cylinders 2 #1, 2 #6, 2 #5, 2 #4, 2 #3, and 2 #2. When the open flag of the calculation window is set, the number of ignitions is counted by the ignition counter 25. When the ignition counter 25 of the setting unit 22 exceeds a count of 12, the ignition counter 25 is returned from the 12th count to the 1st count and a calculation permission flag is set. Moreover, the open flag for the next calculation window is set, and the ignition counter 25 starts counting the number of ignitions again from the first count. In this manner, one calculation interval is set to 12 counts.

Moreover, the recording unit 21 records the crank angular acceleration α for each cylinder. When the setting unit 22 sets the calculation permission flag, the calculation unit 23 obtains the maximum value α1 MAX and the minimum value α1_MIN of the crank angular acceleration of the cylinder 2 #1 in the first calculation window (calculation interval). Furthermore, the calculation unit 23 obtains the difference Δα1 in the crank angular acceleration of the cylinder 2 #1. Although not illustrated, in parallel with a calculation process for the cylinder 2 #1, a similar calculation process is performed for the cylinders 2 #2 to 2 #6. The calculation process of the calculation unit 23 is repeatedly performed every time the calculation permission flag is set.

The difference Δα1 in the crank angular acceleration of the cylinder 2 #1 is equal to or greater than the threshold value TH. Therefore, in the first calculation window, the diagnosis unit 24 diagnoses the cylinder 2 #1 as a misfiring cylinder, and a misfiring cylinder counter 26 #1 for the cylinder 2 #1 is incremented by one. The calculation window is opened and the above process is repeated for each calculation interval, and the misfiring cylinder counter 26 #1 for the cylinder 2 #1 is counted. The diagnosis period is set to be from the start of diagnosis until the crankshaft has rotated 200 times. At the end of the diagnosis period, the misfiring cylinder counter 26 #1 exceeds the predetermined value C2, so the diagnosis unit 24 confirms that the cylinder 2 #1 is a misfiring cylinder and issues a notification.

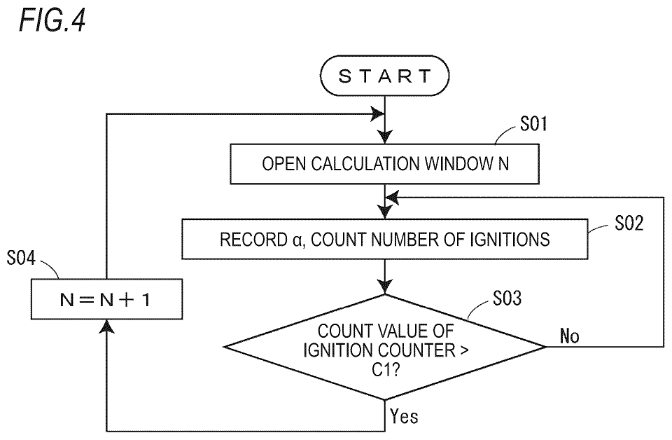

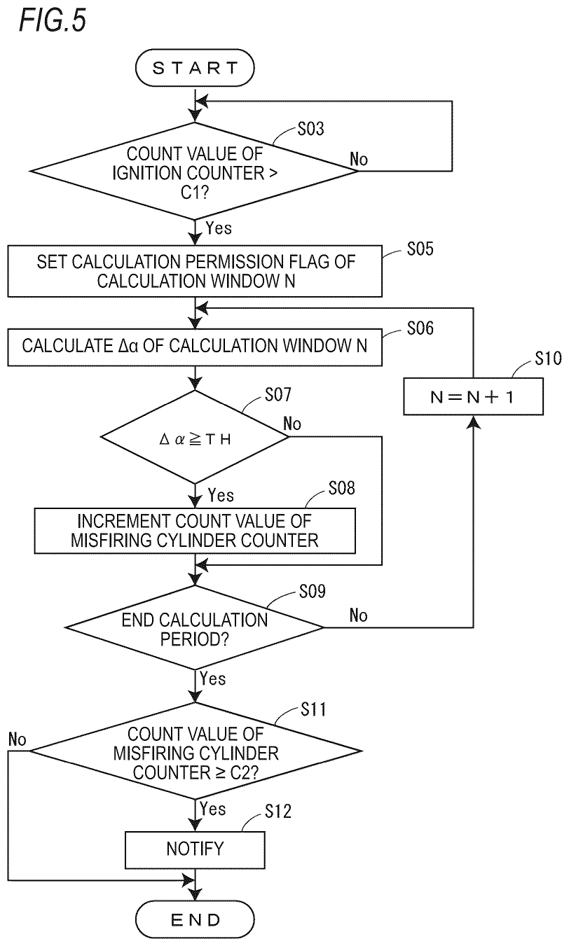

A flow of misfiring cylinder diagnosis will be described with reference to FIGS. 4 and 5. FIG. 4 is a flowchart of a recording process for misfiring cylinder diagnosis according to the first example. FIG. 5 is a flowchart of a calculation process for misfiring cylinder diagnosis in the first example.

As illustrated in FIG. 4, when an Nth calculation window N is opened (step S01), the number of ignitions is counted by the ignition counter 25 and the crank angular acceleration α is recorded for each cylinder (step S02). The process of step S02 is repeated until the count value of the ignition counter 25 exceeds the predetermined value C1 (No in step S03). When the count value of the ignition counter 25 exceeds the predetermined value C1 (Yes in step S03), an (N+1)th calculation window N+1 is opened and the process is restarted from step S01 (step S04). The calculation process for the calculation window N is carried out in parallel with the recording process for the calculation window N+1. The recording process may be stopped at the end of the diagnosis period.

As illustrated in FIG. 5, when the count value of the ignition counter 25 exceeds the predetermined value C1 (Yes in step S03), the calculation permission flag for the calculation window N is set (step S05). A difference Δα between the maximum value α_MAX and the minimum value α_MIN of the crank angular acceleration is obtained for each cylinder in the calculation window N (calculation interval N) (step S06). When the difference Δα in the crank angular acceleration of each cylinder is equal to or greater than the threshold value TH (Yes in step S07), the count value of the misfiring cylinder counter 26 of each cylinder is incremented (step S08). When the diagnosis period for misfiring cylinder diagnosis has not ended (No in step S09), the process returns to step S06 and the calculation process for the calculation window N+1 is performed (step S10).

When the diagnosis period for misfiring cylinder diagnosis ends (Yes in step S09), the count value of the misfiring cylinder counter 26 of each cylinder is compared with the predetermined value C2 (step S11). when there is a cylinder of which the count value of the misfiring cylinder counter 26 is equal to or greater than the predetermined value C2 (Yes in step S11), this cylinder is confirmed to be a misfiring cylinder and this is notified to a user (step S12). The method of notification is not particularly limited, but may be an error message, a mechanical voice, a warning sound, or a warning lamp. Also, the notification may be given when the count value of the misfiring cylinder counter 26 reaches or exceeds the predetermined value C2 even before the end of the diagnosis period.

The predetermined value C1 in step S03 may be set to a value (for example, 6 counts) at which all cylinders make one cycle of ignition, or may be set to a value (for example, 12 counts) at which ignition of all cylinders is repeated a plurality of times. Although the misfiring cylinder is diagnosed based on a comparison result in step S11, the misfiring cylinder may also be diagnosed based on a comparison result in step S07. That is, steps S08 to S11 may be omitted.

As described above, according to the misfire diagnosis device 20 of the first example, the crank angular acceleration α shows a decreasing tendency due to a decrease in combustion energy caused by a misfire, so when a cylinder misfires, the difference Δα between the maximum value α_MAX and the minimum value α_MIN of the crank angular acceleration becomes large. Misfiring cylinders are diagnosed by monitoring the difference in crank angular acceleration for each cylinder. In addition, since the crank angular acceleration α from one cylinder ignition to the next cylinder ignition is used, a misfiring cylinder can be diagnosed with high accuracy without being affected by the next cylinder ignition.

### Second Example

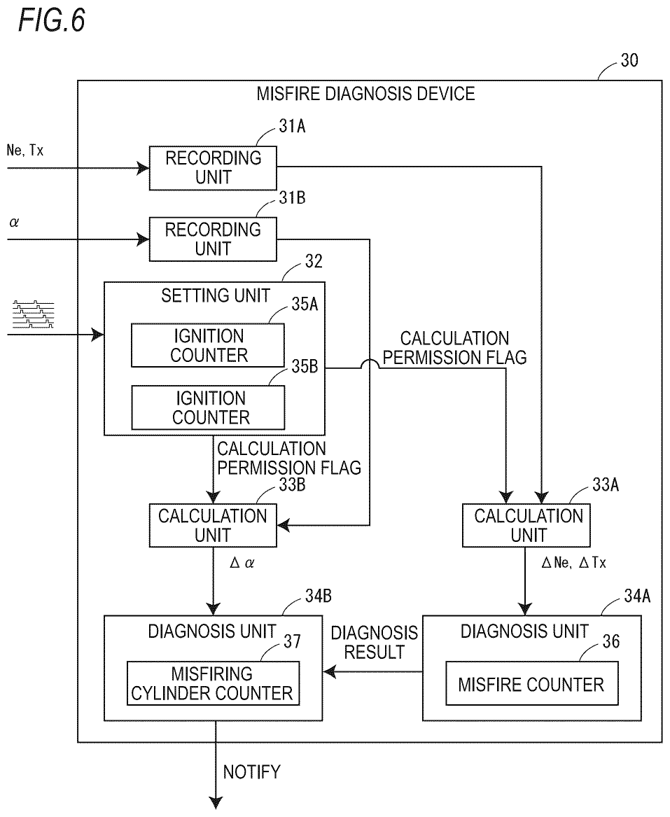

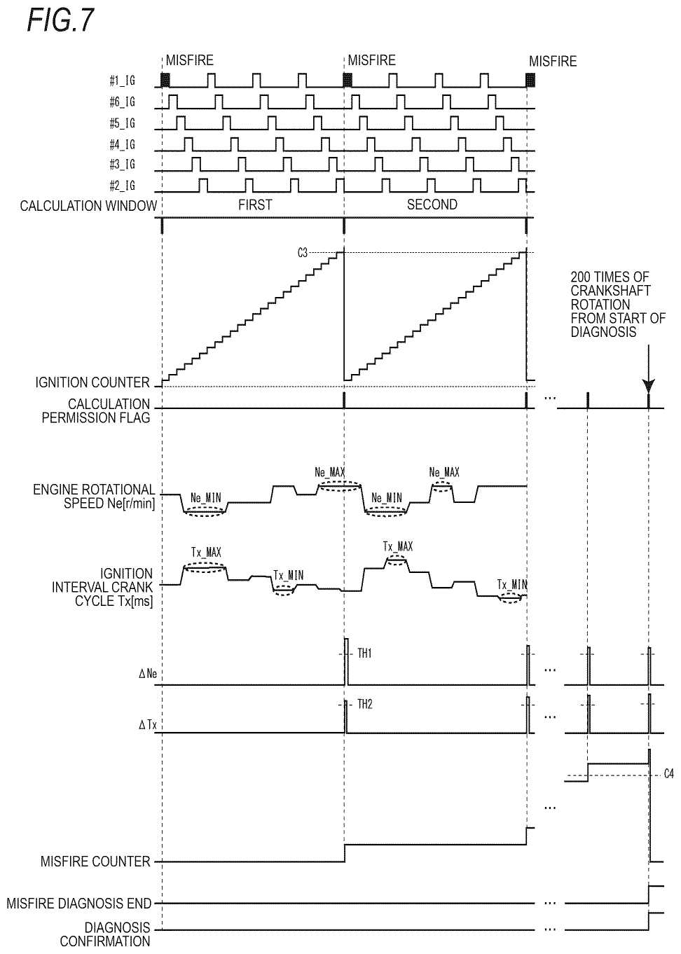

Next, a misfire diagnosis device according to a second example will be described. FIG. 6 is a functional block diagram of a misfire diagnosis device according to the second example. FIG. 7 is a time chart of misfire diagnosis in the second example. The second example differs from the first example in that an engine misfire diagnosis is performed in parallel with the misfiring cylinder diagnosis, and when the engine is diagnosed as in a misfire state and a misfiring cylinder is diagnosed, the misfiring cylinder is confirmed. Therefore, a description of the configuration corresponding to the first example will be omitted as much as possible.

As illustrated in FIGS. 6 and 7, a misfire diagnosis device 30 includes a setting unit 32 that sets a calculation interval to a period during which at least all cylinders 2 #1 to 2 #6 make one cycle of ignition, a recording unit 31A that records misfire index values that indicate a misfire state of several cylinders, a calculation unit 33A that calculates a difference between a maximum value and a minimum value of the misfire index value in the calculation interval, and a diagnosis unit 34A that diagnoses a misfire state when the difference in the misfire index value is equal to or greater than a threshold value. Further, although detailed description will be omitted, the misfire diagnosis device 30 includes a recording unit 31B, a calculation unit 33B, and a diagnosis unit 34B which correspond to the recording unit 21, the calculation unit 23, and the diagnosis unit 24 of the first example.

The setting unit 32 receives a pulse signal from the ECU 5 in accordance with the ignition timing of each of the cylinders 2 #1 to 2 #6. The setting unit 32 is provided with an ignition counter 35A, which counts every time an ignition occurs in each of the cylinders 2 #1 to 2 #6 based on the pulse signal. Counting begins after an open flag of a calculation window is set, and when the ignition counter 35A exceeds a predetermined value C3, it is returned to the first count. When the ignition counter 35A reaches a count of one, an open flag for a next calculation window is set. A counting period from when the open flag of the calculation window is set to the predetermined value C3 of the ignition counter 35 is set as the calculation interval.

When the ignition counter 35A counts up to the predetermined value C3, it is determined that the first calculation interval has elapsed and the setting unit 32 sets a calculation permission flag. Further, the setting unit 32 sets not only the calculation interval for the misfire diagnosis of the engine 1 but also the calculation interval for the misfiring cylinder diagnosis (see FIG. 3). For this reason, the setting unit 32 is provided with an ignition counter 35B for misfiring cylinder diagnosis, which returns to the first count when the count exceeds the predetermined value C1. The calculation intervals may be set to the same length for the misfire diagnosis and the misfiring cylinder diagnosis, or calculation intervals of different lengths may be set for the misfire diagnosis and the misfiring cylinder diagnosis.

The recording unit 31A records the engine rotational speed Ne and the ignition interval crank cycle Tx calculated by the ECU 5 (see FIG. 1) as misfire index values. When a misfire occurs in any of the cylinders 2 #1 to 2 #6, combustion energy decreases due to the misfire, and the engine rotational speed Ne decreases while the ignition interval crank cycle Tx becomes longer. The misfire diagnosis device 30 diagnoses whether there is a misfire in the engine 1 by utilizing the characteristics of the engine rotational speed Ne and the ignition interval crank cycle Tx. The recording unit 31A may record either the engine rotational speed Ne or the ignition interval crank cycle Tx as the misfire index value. The ignition interval crank cycle Tx is the rotation time of the crankshaft from the ignition of one cylinder to the ignition of the next cylinder, and in this example indicates the time required for the crankshaft to rotate 120°.

When the calculation permission flag is set in the setting unit 32, the calculation unit 33A calculates the difference between the maximum value and the minimum value of the misfire index value in the calculation interval. That is, the misfire index value in the calculation interval until the calculation permission flag is set is monitored, the calculation unit 33A obtains the maximum value and the minimum value of the misfire index value, and further the calculation unit 33A calculates the difference between the maximum value and the minimum value of the misfire index value. A difference ΔNe between a maximum value Ne_MAX and a minimum value Ne_MIN of the engine rotational speed in the calculation interval is obtained, and a difference ΔTx between a maximum value Tx MAX and a minimum value Tx_MIN of the ignition interval crank cycle in the calculation interval is obtained.

In the diagnosis unit 34A, the difference ΔNe in the engine rotational speed is compared with a first threshold value TH1 for each calculation interval, and the difference ΔTx in the ignition interval crank cycle is compared with a second threshold value TH2 for each calculation interval. When the difference ΔNe in the engine rotational speed is equal to or greater than the first threshold value TH1 and the difference ΔTx in the ignition interval crank cycle is equal to or greater than the second threshold value TH2, the diagnosis unit 34A diagnoses a misfire state. When the difference ΔNe in the engine rotational speed is less than the first threshold value TH1 and/or the difference ΔTx in the ignition interval crank cycle is less than the second threshold value TH2, the diagnosis unit 34A diagnoses that a misfire is not occurring.

As described above, the engine rotational speed Ne and the ignition interval crank cycle Tx can be recorded simultaneously, and the diagnosis unit 34A can simultaneously diagnose a combustion state of the engine 1 using different index values, thereby improving diagnostic accuracy. The diagnosis unit 34A is also provided with a misfire counter 36, which is incremented each time the diagnosis unit 34A diagnoses a misfire state. Then, when the diagnosis period has elapsed, the diagnosis unit 34A performs a final diagnosis, and when the count value (the number of diagnoses in which a misfire state has been diagnosed) of the misfire counter 36 is equal to or greater than a predetermined value (predetermined number of times) C4, the diagnosis unit 34A confirms that there is a misfire in the engine 1 and notifies the diagnosis unit 34B of the diagnosis result.

When the diagnosis unit 34B diagnoses a cylinder as a misfiring cylinder, the cylinder is confirmed as a misfiring cylinder and a notification is issued. The first and second threshold values TH1, TH2 and the predetermined values C3, C4 are set to values experimentally, empirically, and theoretically obtained from past data or the like. The diagnosis period is set to the rotational speed (200 revolutions in this example) of the crankshaft. When the rotational speed of the crankshaft reaches a predetermined rotational speed from the start of the diagnosis, the misfire counter 36 is reset. Also, the diagnosis unit 34A may diagnose a misfire state based on only one of the difference ΔNe in the engine rotational speed and the difference ΔTx in the ignition interval crank cycle.

Each control block of the misfire diagnosis device 30 may be implemented by software using a processor, or may be implemented by a logic circuit (hardware) formed in an integrated circuit or the like. When the processor is used, the processor reads and executes a program stored in a memory to perform various processes. As the processor, for example, a Central Processing Unit (CPU) is used. The memory is composed of one or more storage media such as a Read Only Memory (ROM) and a Random Access Memory (RAM) depending on the application.

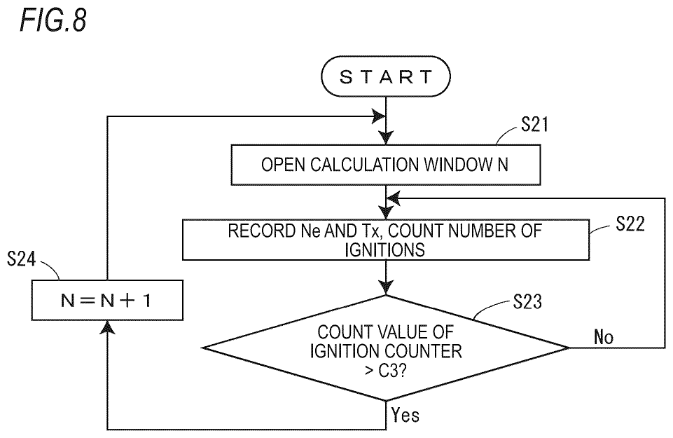

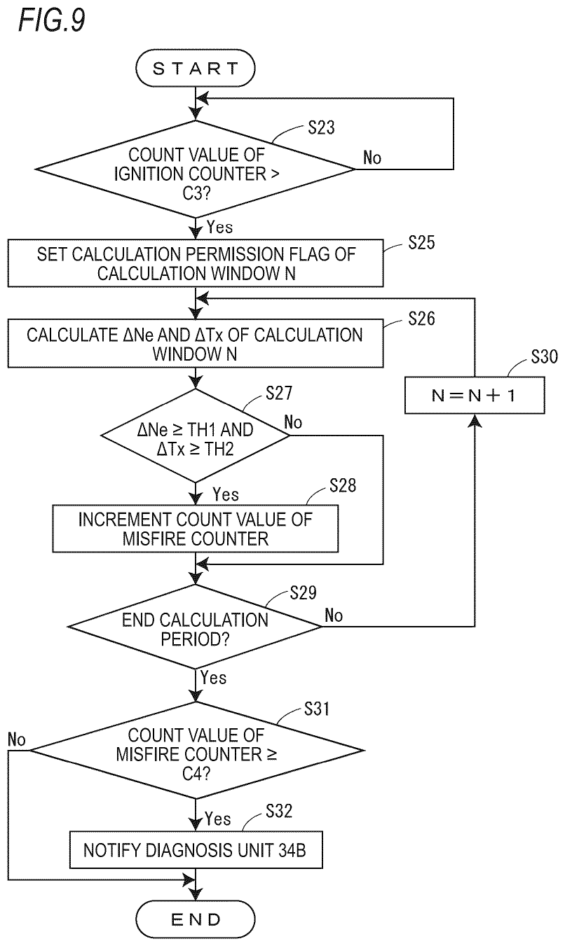

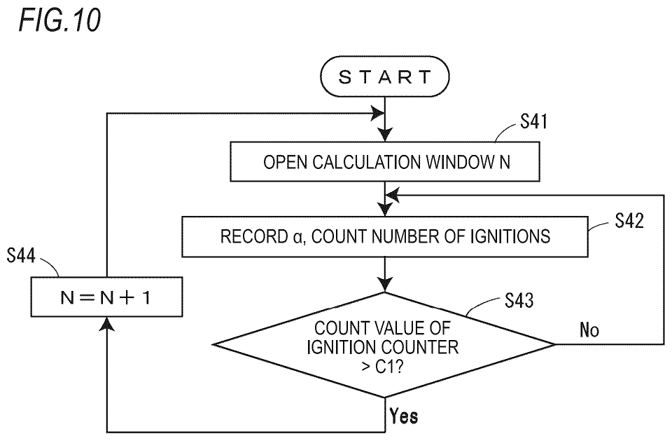

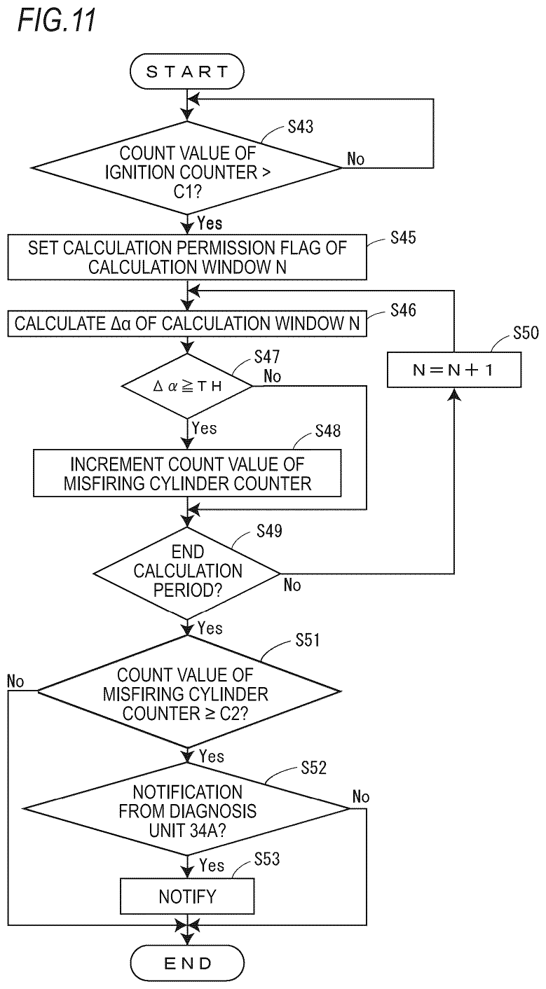

A flow of misfire diagnosis will be described with reference to FIGS. 8 to 11. FIG. 8 is a flowchart of a recording process for the misfire diagnosis according to the second example. FIG. 9 is a flowchart of a calculation process for the misfire diagnosis according to the second example. FIG. 10 is a flowchart of a recording process for misfiring cylinder diagnosis according to the second example. FIG. 11 is a flowchart of a calculation process for the misfiring cylinder diagnosis according to the second example. In addition, the misfiring cylinder diagnosis is performed in parallel with the misfire diagnosis of the second example. However, the misfiring cylinder diagnosis in the second example differs from that in the first example in that a misfire diagnosis result is referenced.

As illustrated in FIG. 8, when an Nth calculation window N is opened (step S21), the number of ignitions is counted by the ignition counter 35A, and the engine rotational speed Ne and the ignition interval crank cycle Tx are recorded (step S22). The process of step S22 is repeated until the count value of the ignition counter 35A exceeds the predetermined value C3 (No in step S23). When the count value of the ignition counter 35A exceeds the predetermined value C3 (Yes in step S23), an (N+1)th calculation window N+1 is opened and the process is restarted from step S21 (step S24). The calculation process for the calculation window N is carried out in parallel with the recording process for the calculation window N+1. The recording process may be stopped at the end of the diagnosis period.

As illustrated in FIG. 9, when the count value of the ignition counter 35A exceeds the predetermined value C3 (Yes in step S23), the calculation permission flag for the calculation window N is set (step S25). In the calculation window N (calculation interval N), the difference ΔNe between the maximum value Ne_MAX and the minimum value Ne_MIN of the engine rotational speed and the difference ΔTx between the maximum value Tx MAX and the minimum value Tx_MIN of the ignition interval crank cycle are obtained (step S26). When the difference ΔNe in the engine rotational speed is equal to or greater than the first threshold value TH1 and the difference ΔTx in the ignition interval crank cycle is equal to or greater than the second threshold value TH2 (Yes in step S27), the count value of the misfire counter 36 is incremented (step S28). When the diagnosis period for misfire diagnosis has not ended (No in step S29), the process returns to step S26 and the calculation process for the calculation window N+1 is performed (step S30).

When the diagnosis period for misfire diagnosis ends (Yes in step S29), the count value of the misfire counter 36 is compared with the predetermined value C4 (step S31). When the count value of the misfire counter 36 is equal to or greater than the predetermined value C4 (Yes in step S31), the misfire state of the engine 1 is confirmed, and the diagnosis result is notified to the diagnosis unit 34B (step S32). In the misfiring cylinder diagnosis illustrated in FIGS. 10 and 11, the processing (similar to the processing of steps S01 to S11) of steps S41 to S51 is carried out, and when there is a cylinder of which the count value of the misfiring cylinder counter 37 is equal to or greater than the predetermined value C2 in step S51 (Yes in step S51), it is determined whether a notification has been received from the diagnosis unit 34A (step S52). When a notification has been received from the diagnosis unit 34A (Yes in step S52), the misfiring cylinder is confirmed and notified to the user (step S53).

In steps S22, S26, and S27, the engine rotational speed Ne and the ignition interval crank cycle Tx are used as the misfire index value, but either the engine rotational speed Ne or the ignition interval crank cycle Tx may be used as the misfire index value. The predetermined value C1 in step S23 may be set to a value (for example, 6 counts) at which all cylinders make one cycle of ignition, or may be set to a value (for example, 24 counts) at which ignition of all cylinders is repeated a plurality of times. Although a misfire diagnosis is performed based on a comparison result of step S31, a misfire may also be diagnosed based on a comparison result of step S27. That is, steps S28 to S31 may be omitted.

As described above, according to the misfire diagnosis device 30 of the second example, the misfire state of the engine 1 is diagnosed, and when a misfiring cylinder is diagnosed, the misfiring cylinder is confirmed, thereby improving the diagnostic accuracy.

In the second example, the engine rotational speed and the ignition interval crank cycle are exemplified as the misfire index value, but the misfire index value is not particularly limited as long as it is an index value that indicates a misfire state.

In addition, in the first and second examples, a six-cylinder engine is exemplified as the engine, but the engine is not particularly limited as long as it has a plurality of cylinders.

Furthermore, the ECU may function as the misfire diagnosis device, or the misfire diagnosis device may be provided separately from the ECU.

Also, a misfire diagnosis function may be added by installing a program in the ECU. This program may be stored in a storage medium. The storage medium is not particularly limited, and may be a non-transitory storage medium such as an optical disk, a magneto-optical disk, or a flash memory.

Furthermore, the misfire diagnosis device of this example is not limited to being applied to engines of outboard motors, but may be applied to engines of other vehicles.

As described above, a misfire diagnosis device (20, 30) of a first aspect of the present invention is a misfire diagnosis device that diagnoses presence or absence of a misfire in an engine (1) having a plurality of cylinders (2 #1 to 2 #6), and includes a setting unit (22, 32) that sets a calculation interval to a period during which at least all cylinders make one cycle of ignition, a recording unit (21, 31B) that records a crank angular acceleration from one cylinder ignition to next cylinder ignition for each cylinder, a calculation unit (23, 33B) that calculates a difference between a maximum value and a minimum value of the crank angular acceleration in the calculation interval for each cylinder, and a diagnosis unit (24, 34B) that diagnoses, for each cylinder, a cylinder for which the difference in the crank angular acceleration is equal to or greater than a threshold value as a misfiring cylinder. The crank angular acceleration is an index indicating whether the rotational speed of a crankshaft is increasing or decreasing. Since the crank angular acceleration shows a decreasing tendency due to a decrease in combustion energy caused by a misfire, the difference between the maximum value and the minimum value of the crank angular acceleration becomes large when a cylinder misfires. Misfiring cylinders are diagnosed by monitoring the difference in crank angular acceleration for each cylinder. In addition, since the crank angular acceleration from one cylinder ignition to the next cylinder ignition is used, a misfiring cylinder can be diagnosed with high accuracy without being affected by the next cylinder ignition.

In a second aspect, in the first aspect, the setting unit sets the calculation interval to a period during which ignition of all cylinders is repeated a plurality of times. According to this configuration, it is possible to diagnose misfiring cylinders, including cases where a particular cylinder misfires only once in multiple ignitions.

In a third aspect, in the first or second aspect, the diagnosis unit confirms, at the time when a diagnosis period elapses, that a cylinder that is diagnosed as being in a misfire state a predetermined number of times or more is a misfiring cylinder. According to this configuration, when a misfiring cylinder is repeatedly diagnosed, the misfiring cylinder is confirmed, thereby improving the diagnostic accuracy.

A fourth aspect includes, in any one of the first to third aspects, another recording unit (31A) that records a misfire index value indicative of a misfire state of some cylinders, another calculation unit (33A) that calculates a difference between a maximum value and a minimum value of the misfire index value in the calculation interval, and another diagnosis unit (34A) that diagnoses a misfire state when the difference in the misfire index value is equal to or greater than a threshold value, where when the another diagnosis unit diagnoses the engine as being in a misfire state and the diagnosis unit diagnoses a misfiring cylinder, the misfiring cylinder is confirmed. According to this configuration, the misfire state of the engine is diagnosed, and when a misfiring cylinder is diagnosed, the misfiring cylinder is confirmed, thereby improving the diagnostic accuracy.

A fifth aspect is a program for a misfire diagnosis device that diagnoses presence or absence of a misfire in an engine having a plurality of cylinders, the program causing the misfire diagnosis device to execute the steps of setting a calculation interval to a period during which at least all cylinders make one cycle of ignition, recording a crank angular acceleration from one cylinder ignition to next cylinder ignition for each cylinder, calculating a difference between a maximum value and a minimum value of the crank angular acceleration in the calculation interval for each cylinder, and diagnosing, for each cylinder, a cylinder for which the difference in the crank angular acceleration is equal to or greater than a threshold value as a misfiring cylinder. According to this configuration, by installing the program in an engine control device or the like, the control device or the like can be used as a misfiring cylinder diagnosis device.

Although the present example is described, other examples may be made by combining the above-described example and modification examples in whole or in part.

Furthermore, the technology of the present invention is not limited to the above-described example, and may be modified, substituted, or changed in various ways without departing from the spirit and scope of the technical concept. Furthermore, when technological advances or derived technologies allow the technical ideas to be realized in a different way, they may be implemented using that method. Therefore, the claims cover all embodiments that may fall within the scope of the technical concept.

1. A misfire diagnosis device that diagnoses presence or absence of a misfire in an engine having a plurality of cylinders, comprising:
a setting unit configured to set a calculation interval to a period during which at least all cylinders make one cycle of ignition;
a recording unit configured to record a crank angular acceleration from one cylinder ignition to next cylinder ignition for each cylinder;
a calculation unit configured to calculate a difference between a maximum value and a minimum value of the crank angular acceleration in the calculation interval for each cylinder; and
a diagnosis unit configured to diagnose, for each cylinder, a cylinder for which the difference in the crank angular acceleration is equal to or greater than a threshold value as a misfiring cylinder.

2. The misfire diagnosis device according to claim 1, wherein the setting unit sets the calculation interval to a period during which ignition of all cylinders is repeated a plurality of times.

3. The misfire diagnosis device according to claim 1, wherein the diagnosis unit confirms, at the time when a diagnosis period elapses, that a cylinder that is diagnosed as being in a misfire state a predetermined number of times or more is a misfiring cylinder.

4. The misfire diagnosis device according to claim 1, further comprising:
another recording unit configured to record a misfire index value indicative of a misfire state of some cylinders;
another calculation unit configured to calculate a difference between a maximum value and a minimum value of the misfire index value in the calculation interval; and
another diagnosis unit configured to diagnose a misfire state when the difference in the misfire index value is equal to or greater than a threshold value, wherein
when the another diagnosis unit diagnoses the engine as being in a misfire state and the diagnosis unit diagnoses a misfiring cylinder, the misfiring cylinder is confirmed.

5. A non-transitory storage medium storing a program a program for a misfire diagnosis device that diagnoses presence or absence of a misfire in an engine having a plurality of cylinders, the program causing at least one processor to execute procedures comprising:
setting a calculation interval to a period during which at least all cylinders make one cycle of ignition;
recording a crank angular acceleration from one cylinder ignition to next cylinder ignition for each cylinder;
calculating a difference between a maximum value and a minimum value of the crank angular acceleration in the calculation interval for each cylinder; and
diagnosing, for each cylinder, a cylinder for which the difference in the crank angular acceleration is equal to or greater than a threshold value as a misfiring cylinder.
